(19) United States
(12) Patent Application Publication
(10) Pub. No.: US 2007/0277191 A1
(43) Pub. Date: Nov. 29, 2007

(54) Method Of Optical Data Storage

(76) Inventors: Mark Andrew Englund, Mosman (AU); Lars Goran Edvell, Holesworthy (AU); Andrew Graf, Hurlstone Park (AU)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/573,428

(22) PCT Filed: Sep. 27, 2004
(86) PCT No.: PCT/AU04/01307

§ 371 Date: Dec. 6, 2006

(30) Foreign Application Priority Data
Sep. 25, 2003 (AU) 2003905247

(51) Int. Cl. G02B 6/10

(52) U.S. Cl. 720/718

(57) ABSTRACT

The present invention provides a method of storing data in an optical data storage device. The method comprises the step of encoding information and determining a multi-channel grating structure for the encoded information. The method further comprises the step of applying the grating structure to an optical waveguide in a manner such that in use the multi-channel grating will effect a change of a property of optical radiation that passes through the waveguide. The change of the property is characteristic for the encoded information. The present invention further provides an optical read only memory having a multi-channel grating.

### FIELD OF THE INVENTION

The present invention broadly relates to a method of optical data storage and to an optical read-only memory.

### BACKGROUND OF THE INVENTION

The amount of optical fibre that is being installed is constantly increasing. Metropolitan areas already have dense networks of optical fibres. For example, in exchange stations often hundreds of fibres are branching and crossing. Installation of fibre networks and manual routing changes therefore are difficult tasks and mistakes can be made. The optical fibres are typically marked so that they can be identified, but suitable markings such as bar codes on the fibres are not ideal as they can only be identified locally. Optical fibres often have a length of many (hundreds) kilometres and a large number of bar codes needs to be applied to the fibres in intervals to ensure that the optical fibre can be identified at any interrogation position.

There is a need for a better method of coding fibres and thereby storing data associated with the fibres that allows the identification of the fibres at different locations without the need to apply a large number of bar codes.

Further, optical radiation that is guided through the fibres typically transmits encoded information. The encoded information often is stored in data storage devices, such as electronic hard-drives or optical devices such as CD drives. However, such data storage devices typically are mechanically complex and sensitive devices. For example, CD drives are often sensitive to mechanical impact and the CD's themselves are often easily damaged by scratching their surfaces. There is therefore a need for an alternative data storage device.

### SUMMARY OF THE INVENTION

The present invention provides in a first aspect a method of storing data in an optical data storage device, the method comprising the steps of:

encoding information and determining a multi-channel grating structure for the encoded information and

applying the grating structure to an optical waveguide in a manner such that in use the multi-channel grating will effect a change of a property of optical radiation that passes through the waveguide, the change of the property being characteristic for the encoded information.

The method typically also comprises the step of detecting the change of the property to retrieve the information.

The multi-channel grating typically has a grating structure that may be created by superposition a plurality of second, typically simpler, grating structures. Because of the superposition, the gratings can be relatively short and it is possible to store a relatively large amount of encoded information in a relatively short grating. As the encoded information is stored in the waveguide, such as in a core of a waveguide, mechanical robustness typically is larger than that of conventional data storage devices such as CD drives drives. The encoded information is retrievable from the optical radiation that passed through the multi-channel waveguide and retrieval of the encoded information, for example using a suitable optical analyser, typically only requires a minimum of mechanical components. Further, the optical information may be stored (and retrieved) in a manner that is not affected by water.

The information may be of any type. The grating typically functions as a read only memory (ROM) that may store coded information corresponding to a large number of bits such as Kbits, Mbits or Gbits.

In one alternative example, the information relates to a code that is useable to identify the optical waveguide. In this case often only a relatively small amount of information may be stored. As the multi-channel grating is detectable by optical radiation that passes through the waveguide, the waveguide may be identifiable, or the information may be retrievable, at any interrogation position along the waveguide even if the multi-channel grating itself is remote from the position of interrogation.

The multi-channel grating typically is a Bragg grating that has information encoded which is retrievable from an amplitude and/or phase response of the Bragg grating in the spectral domain as a function of wavelength. The multi-channel grating typically has a periodic refractive index profile that has an envelope which is characteristic for the encoded information.

The step of encoding the information may comprise usage of encoding schemes such as phase shift keying and preferably comprises phase amplitude keying (PAK).

The present invention provides in a second aspect an optical storage device in which data is stored using the above-defined method.

The present invention provides in a third aspect an optical read-only memory (ROM) comprising a waveguide having a multi-channel grating having a grating structure which is associated with encoded information and that in use effects a change of a property of optical radiation that passes through the multi-channel grating, the change of the property being characteristic for the encoded information.

The multi-channel grating typically has a refractive index profile that is of the type being creatable by a superposition of a plurality of second refractive index profiles having different spatial frequencies. In one embodiment, each second refractive index profile is associated with a single channel of the multi-channel grating. Alternatively, the refractive index profile of the multi-channel grating may be of the type that produces a noise like amplitude (ie. reflectivity) response that typically is continuous.

The multi-channel grating typically is a Bragg grating that has a number of possible phase and amplitude levels for each channel. Further, each channel may have a number of wavelength divisions. For example, each channel of the multi-channel grating may have a number of possible different phase and amplitude levels. In this example, the number of different encoded bit sequences corresponds to the product of the number of channels, the number of wavelength divisions per channel, the number of phase levels, and the number of amplitude levels. Consequently, it is possible to store a relatively large amount of data in the ROM.

The grating typically has a specific amplitude and/or phase response as a function of wavelength. The grating typically has a refractive index variation that has a profiled envelope along the length of the grating.

The present invention provides in a fourth aspect a method of reading information from an optical data storage device, the data storage device comprising a multi-channel grating which has a refractive index variation that is associated with encoded information, the method comprising the steps of:

directing optical radiation to the multi-channel grating so that the multi-channel grating will effect a change of a property of the optical radiation, receiving the optical radiation having experienced the change of the property and thereafter processing the optical radiation to obtain the information.

The information may be of any type and the multi-channel may function as a read only memory (ROM). In one example, the information is useable to identify an optical waveguide in which the multi-channel grating may be positioned.

A Laser pulse may be directed through the optical waveguide to the multi-channel grating. At least a portion of the optical radiation may be reflected or transmitted by the multi-channel grating and the step of processing the optical radiation may comprise analysing the reflected or transmitted optical radiation to identify an amplitude and/or phase response of the multi-channel grating.

The step of directing optical radiation to the multi-channel grating may comprise directing light from a tunable laser to the multi-channel grating. In this case, the method may further comprise scanning the wavelength of the laser through a wavelength range that corresponds to the channels of the multi-channel grating. Alternatively, a laser pulse such as a square pulse may be directed to the multi-channel grating and phase and amplitude changes of the laser pulse may be detected to retrieve the information.

In one embodiment, the encoded information comprises directions for the installation of the optical waveguide. In this case the method may comprise the additional step of installing the waveguide according to the directions. For example, the optical waveguide may be an optical fibre and the step of installing the optical fibre may comprise splicing the optical fibre according to the directions.

The method may be conducted in an automated way in which the obtained information is processed and used to install a plurality of optical fibres in a predetermined manner.

The present invention provides in a fifth aspect a method of testing an optical network, the optical network comprising optical waveguides, each optical waveguide having a multi-channel grating which has a refractive index variation that is associated with encoded information, the method comprising the steps of:

directing optical radiation to the multi-channel gratings so that the multi-channel gratings will effect a change of a property of the optical radiation,

receiving the optical radiation having experienced the change of the property and thereafter processing the optical radiation to obtain the information.

The present invention provides in a sixth aspect a method of installing an optical network, the optical network comprising optical waveguides, the method comprising the steps of:

directing optical radiation to the multi-channel gratings so that the multi-channel gratings will effect a change of a property of the optical radiation, each multi-channel grating having a refractive index variation that is associated with encoded information,

receiving the optical radiation having experienced the change of the property, thereafter

processing the optical radiation to obtain the information and

installing the optical network utilising the information.

The invention will be more fully understood from the following description of specific embodiments of the invention. The description is provided with reference to the accompanying drawings.

### BRIEF DESCRIPTION OF THE DRAWINGS

FIG. 1 shows a schematic representation of an optical storage device according to a specific embodiment of the invention,

FIG. 2 shows a plot of grating amplitude versus position for the device shown in FIG. 1,

FIG. 3 shows a plot of grating phase versus position for the device shown in FIG. 1,

FIG. 4 shows a phase shift versus position plot for an optical storage device according to another specific embodiment of the present invention and

FIGS. 5 (a) and (b) show reflection versus wavelength plots for the optical storage device for which the phase shift versus position plot is shown in FIG. 4.

### DETAILED DESCRIPTION OF SPECIFIC EMBODIMENTS

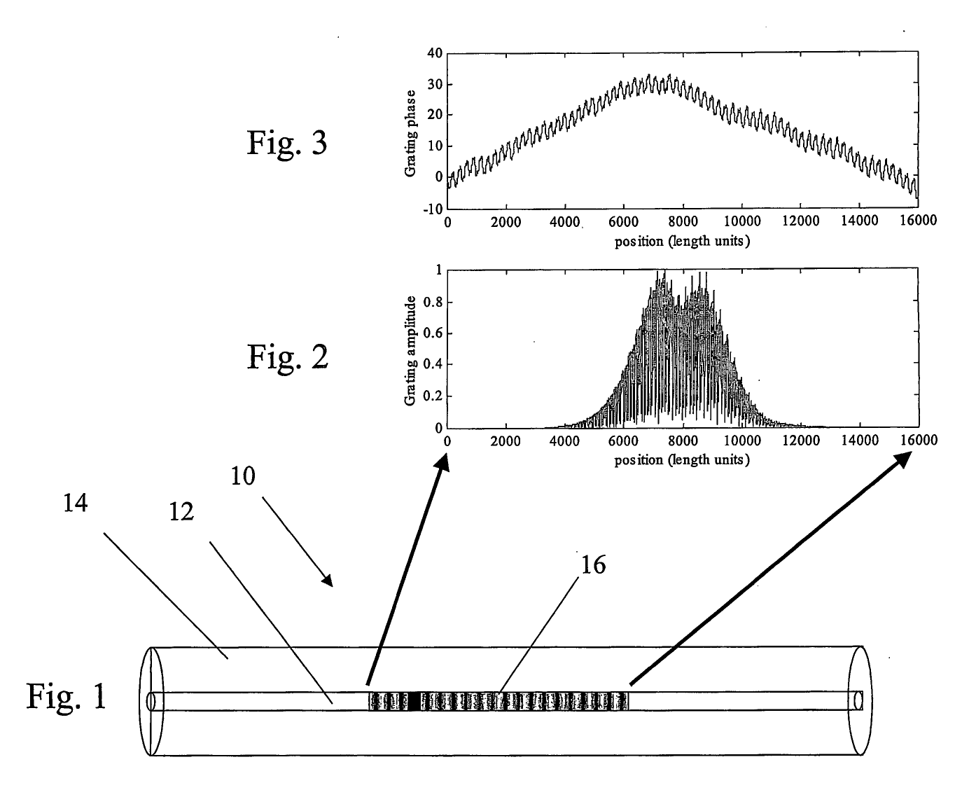

Referring to FIG. 1, an optical storage device according to an embodiment of the present invention is now described. In this embodiment the optical storage device is provided in form of an optical fibre 10. The optical fibre 10 has a core 12 and a cladding 14. Written into the core 12 is a refractive index variation that forms a multi-channel Bragg grating 16. FIGS. 2 and 3 show the amplitude and phase versus position plots for the grating 16 which correspond to encoded information. Light of suitable wavelength that is directed through the Bragg grating 16 will experience changes in amplitude and phase that are characteristic for the encoded information and the light can be processed to retrieve the encoded information.

In this embodiment, the Bragg grating 16 has a profiled envelope. Varying an amplitude of the envelope of the refractive index profile has a direct analogy to AM radio where audio information is impressed on the envelope of an RF carrier tone. However in this particular application the information is impressed on a envelope of a sinusoidally varying refractive index pattern along the length of the grating. The envelope is defined as amplitude A(z) of a periodic signal:
F(z)=A(z)·sin(omega(z)·z) eq. (1)
F(z): sinusoidal signal in space
Omega: angular spatial frequency (rads/m)
z: spatial ordinate (m)

Varying A(z) as a function of the dependent variable is equivalent to varying the envelope of the refractive index profile of the Bragg grating 16.

Varying omega(z)·z as a function of the dependent variable is equivalent to varying the phase of the refractive index profile of the Bragg grating 16.

The Bragg grating 16 may have any number, such as 80, of distinct channels that correspond to different wavelengths. Using a multilevel coding scheme such as phase amplitude shift keying, each bit of a bit sequence may be converted into a specific phase/amplitude coordinate code in a phase/amplitude coordination system. A Bragg grating such as grating 16 having the specific phase and amplitude properties may then be written using conventional techniques.

For example, each channel of the multi-channel grating may have a number of possible different phase and amplitude levels. Further, each channel may have a number of wavelength divisions. In a specific example, each channel has 8 possible phase levels, 8 possible amplitude levels and 5 wavelengths divisions. Therefore, the number of possible combinations is 81×8×8×5=25920 and a grating of this type can store one of 25920 different encoded bit sequences. It will be appreciated that the number of channels, amplitude levels, phase levels, and wavelength divisions may alternatively be significantly larger (or smaller) than those in the specific example. The Bragg grating 16 thus is a read-only memory that has a memory size which depends on these parameters. For example, the grating may be arranged to have a memory size of several Mb or more.

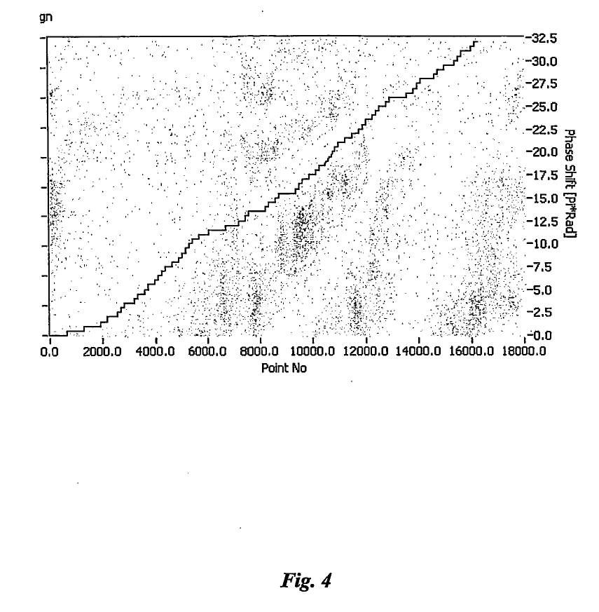

FIG. 4 shows a phase shift versus position plot for an optical storage device according to another embodiment of the present invention. In this embodiment, a length of a grating with a single spatial period may be encoded with a high number of discrete phase shifts of varying magnitude and at random position along the fibre FIG. 4 shows a phase shift versus position plot for an optical storage device according to another embodiment of the present invention and

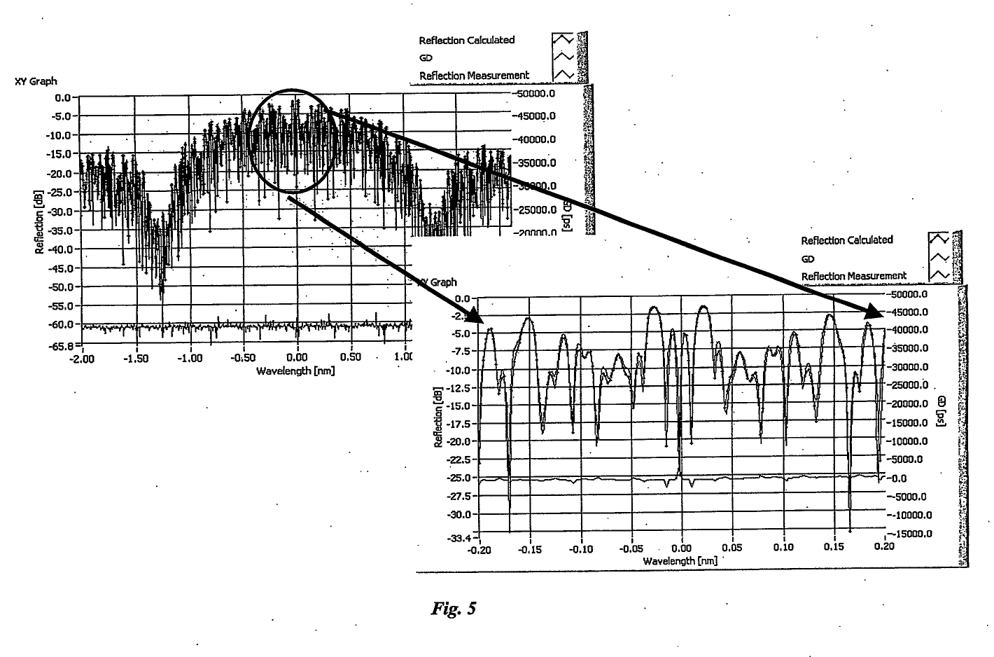

FIGS. 5 (a) and (b) show the resulting amplitude (reflectivity) response which is a noise like spectrum. To increase the data storage using this approach a number of these phase shift grating may be superimposed in a design and written in a single exposure producing a broad but continuous noise like amplitude response (reflectivity) that is detected and demodulated to read the information encoded.

To read the read only memory, a laser may be used such as a multi-longitudinal mode Fabry Perot semiconductor laser. In this example, the laser has resonances that correspond to the channels of the grating 16. The laser may generate a square pulse which is directed through the fibre core 12 to the grating 16. The laser light will experience amplitude and phase changes and a portion of the pulse is reflected by the grating. Owing to the amplitude and phase changes, the envelope of the pulse will be changed. The reflected light is then detected and converted into an electrical signal. The converted signal is then processed by a microprocessor to retrieve the information that is encoded in the Bragg grating 16.

Alternatively, a tunable laser may be used to generate the optical radiation. The wavelength of the laser may be scanned across the channels of the multi-channel grating. A phase and amplitude sensitive detector detects the optical signal that is reflected from the multi-channel grating. In a multi-level decoding sequence the signal may be decoded and the information retrieved.

For example, the information that is encoded into the Bragg grating 16 may be useable to identify the optical fibre itself. As the Bragg grating 16 is detectable by optical radiation that passes through the waveguide, the fibre 10 may be uniquely identifiable at any interrogation position along the fibre 12 even if the Bragg grating itself is remote from the position of interrogation.

In another example, the encoded information comprises directions for the installation of the optical fibre 10. For example, the encoded information may comprise direction for splicing fibres. In this example, the encoded information may enable “intelligent splicing” in which a plurality of fibres (that are potentially different) are spliced together in an automated way to form a predetermined configuration which can be automatically verified by reading the code.

The encoded information can also be of use for testing optical networks. Each optical waveguide (planar waveguide or fibre) in the network may comprise a Bragg grating that has encoded information which can be used to identify the respective waveguide. For example, the laser radiation may be directed to a plurality of the waveguides and the light that is reflected from the Bragg gratings can be processed to characterise the network. For example, it may be identified if a response from an optical code in a particular optical waveguide is not present which would indicate a defect. Further, optical codes may be at a predetermined position within the waveguides of the network. For example, the radiation that is reflected by the respective Bragg gratings may be tested for chromatic dispersion, polarisation-mode dispersion (PMD) and signal attenuation. Results may be used to derive information about the quality of signal transmission at the known position of the optical codes.

Although the invention has been described with reference to particular examples, it will be appreciated by those skilled in the art that the invention may be embodied in many other forms in any type of optical waveguide. For example, the optical code may not be implemented in form of a Bragg grating. Further, it will be appreciated that the waveguide may take any suitable form including planar optical waveguides and optical fibres made from glass and/or polymeric materials. In addition, it will be appreciated that the information that is stored in the optical storage device may be of any type such as information that can be stored in storage devices such as CD's or computer hard drives.

1. A method of storing data in an optical data storage device, the method comprising the steps of:
encoding information and determining a multi-channel grating structure for the encoded information and
applying the grating structure to an optical waveguide in a manner such that in use the multi-channel grating will effect a change of a property of optical radiation that passes through the waveguide, the change of the property being characteristic for the encoded information.

2. The method as claimed in claim 1 comprising the step of detecting the change of the property to retrieve the information.

3. The method as claimed in claim 1 wherein the multi-channel grating has a grating structure that may be created by superposition of a plurality of second grating structures.

4. The method as claimed in claim 1 wherein the grating functions as a read only memory (ROM).

5. The method as claimed in claim 1 wherein the multi-channel grating is a Bragg grating that has a periodic refractive index profile which has an envelope that is characteristic for the encoded information.

6. The method as claimed in claim 1 wherein the step of encoding the information comprises usage of encoding schemes.

7. An optical storage device in which data is stored using the method as claimed in claim 1.

8. An optical read-only memory (ROM) comprising a waveguide having a multi-channel grating having a grating structure which is associated with encoded information and that in use effects a change of a property of optical radiation that passes through the multi-channel grating, the change of the property being characteristic for the encoded information.

9. The optical read-only memory as claimed in claim 8 wherein the multi-channel grating has a refractive index profile that is of the type being creatable by a superposition of a plurality of second refractive index profiles having different spatial frequencies.

10. The optical read-only memory as claimed in claim 9 wherein each second refractive index profile is associated with a single channel of the multi-channel grating.

11. The optical read-only memory as claimed in claim 9 wherein the refractive index profile of the multi-channel grating is of the type that produces a noise-like amplitude response.

12. The optical read-only memory as claimed in claim 9 wherein the multi-channel grating is a Bragg grating that has a number of possible phase and amplitude levels for each channel.

13. The optical read-only memory as claimed in claim 9 wherein each channel of the multi-channel grating has a number of wavelength divisions.

14. The optical read-only memory as claimed in claim 9 wherein each channel of the multi-channel grating has a number of possible different phase and amplitude levels.

15. The optical read-only memory as claimed in claim 9 wherein the grating has a refractive index variation that has a profiled envelope along the length of the grating.

16. A method of reading information from an optical data storage device, the data storage device comprising a multi-channel grating which has a refractive index variation that is associated with encoded information, the method comprising the steps of:
directing optical radiation to the multi-channel grating so that the multi-channel grating will effect a change of a property of the optical radiation,
receiving the optical radiation having experienced the change of the property and thereafter
processing the optical radiation to obtain the information.

17. The method as claimed in claim 16 wherein the multi-channel grating may function as a read only memory (ROM).

18. The method as claimed in claim 16 wherein the information is useable to identify an optical waveguide in which the multi-channel grating is positioned.

19. The method as claimed in claim 16 comprising the step of directing a Laser pulse to the multi-channel grating.

20. The method as claimed in claim 16 wherein at least a portion of the optical radiation is reflected by the multi-channel grating and the step of processing the optical radiation comprises analysing the reflected optical radiation to identify a response of the multi-channel grating.

21. The method as claimed in claim 16 wherein at least a portion of the optical radiation is transmitted by the multi-channel grating and the step of processing the optical radiation comprises analysing the transmitted optical radiation to identify a response of the multi-channel grating.

22. The method as claimed in claim 16 wherein the step of directing optical radiation to the multi-channel grating comprises directing light from a tunable laser to the multi-channel grating.

23. The method as claimed in claim 22 further comprising the step of scanning the wavelength of the laser through a wavelength range that corresponds to the channels of the multi-channel grating.

24. The method as claimed in claim 16 wherein the step of directing optical radiation to the multi-channel grating comprises directing a laser pulse to the multi-channel grating and phase and amplitude changes of the laser pulse are detected to retrieve the information.

25. The method as claimed in claim 19 wherein the encoded information comprises directions for the installation of the optical waveguide.

26. The method as claimed in claim 25 comprising the additional step of installing the waveguide according to the directions.

27. A method of testing an optical network, the optical network comprising optical waveguides, each optical waveguide having a multi-channel grating which has a refractive index variation that is associated with encoded information, the method comprising the steps of:
directing optical radiation to the multi-channel gratings so that the multi-channel gratings will effect a change of a property of the optical radiation,
receiving the optical radiation having experienced the change of the property and thereafter
processing the optical radiation to obtain the information.

28. A method of installing an optical network, the optical network comprising optical waveguides, the method comprising the steps of:
directing optical radiation to the multi-channel gratings so that the multi-channel gratings will effect a change of a property of the optical radiation, each multi-channel grating having a refractive index variation that is associated with encoded information,
receiving the optical radiation having experienced the change of the property, thereafter
processing the optical radiation to obtain the information and
installing the optical network utilising the information.
